(19) United States
(12) Patent Application Publication
(10) Pub. No.: US 2007/0135969 A1
(43) Pub. Date: Jun. 14, 2007

(54) METHOD AND SYSTEM FOR ADJUSTING THERMOSTAT VIA TELEPHONE

(76) Inventor: Robert Curl, Memphis, TN (US)

Correspondence Address: BELL, BOYD, & LLOYD LLP, P.O. BOX 1135, CHICAGO, IL, 60690, US

(21) Appl. No.: 11/558,240

(22) Filed: Nov. 9, 2006

Related U.S. Application Data
(60) Provisional application No. 60/734,829, filed on Nov. 9, 2005.

(51) Int. Cl. G01M 1/38; G05D 23/00

(52) U.S. Cl. 700/276; 236/1 R

(57) ABSTRACT

A climate control system is presented. The system includes a remote signal input device and a controller. The controller is operable to receive input from the remote signal input device and to control a climate control device. The climate control device is operable to change or maintain an environmental condition. The remote signal input device can be configured to receive an audio input from a speaker of an answering machine. The controller can be configured to control the climate control device by changing a setting of a climate control device control unit. Changing a setting of the climate control device control unit can include turning the climate control device control unit off or on. The controller can be configured to control the climate control device by switching between controlling the climate control device using a first climate control device control unit and a second climate control device control unit.

### RELATED APPLICATIONS

This non-provisional patent application claims priority to and the benefit of U.S. Provisional Patent Application Ser. No. 60/734,829, filed Nov. 9, 2005, the entire contents of which are incorporated herein.

### BACKGROUND

Heating or cooling a home twenty-four hours a day, seven days a week can be inefficient, particularly if the occupants leave the home for work, vacation or a night of entertainment. An occupant can manually turn on or off the heating, ventilation and air conditioning system (HVAC) to improve efficiency; however, such an arrangement could require the occupant to return to an uncomfortable dwelling. Programmable thermostats offer another option for improving efficiency. With a programmable thermostat, the occupant can have the system turn off shortly before the occupant typically leaves the dwelling each day and turn back on with enough time before the occupant typically returns to ensure the dwelling is a comfortable temperature upon the occupant's return. A programmable thermostat can even have different program settings for weekdays and weekends. However, a programmable thermostat is still inefficient if the occupant deviates from a rigid daily or weekly schedule. For example, if the occupant is out for the evening and decides not to return home that night, there is no need for the HVAC system to turn back on.

### SUMMARY

A climate control system is presented in one embodiment. The system includes a remote signal input device and a controller. The controller is operable to receive input from the remote signal input device and control a climate control device at least partly in response to the input. The climate control device is operable to change or maintain an environmental condition of an enclosure. The remote signal input device can be an audio input device. The remote signal input device can be configured to receive an audio input emitted from a speaker of an answering machine. The controller can be configured to control the climate control device if the input includes a password.

The controller can be configured to control the climate control device by changing one or more settings of a climate control device control unit. The climate control device control unit can be a thermostat. Changing one or more settings of the climate control device control unit can include turning the climate control device control unit off or on. The controller can be configured to control the climate control device by switching between controlling the climate control device using a first climate control device control unit and a second climate control device control unit. The system can also include a transmission unit configured to send an acknowledgement signal to a remote communication device. The climate control device can be selected from the group consisting of a heater, a cooler, a humidifier, a dehumidifier, a filtration system, an electronic window tinting system, a blinds system, a curtain system and a shade system.

In another embodiment, a method of controlling an environmental condition of an enclosure is presented. The method includes receiving input at a remote signal input device and controlling a climate control device at least partly in response to the input. The climate control device is operable to change or maintain the environmental condition. The remote signal input device can be an audio input device. Receiving input can include receiving an audio input emitted from a speaker of an answering machine. Controlling the climate control device can include determining whether the input includes a password.

Controlling the climate control device can include changing one or more settings of a climate control device control unit. The climate control device control unit can be a thermostat. Changing one or more settings of the climate control device control unit can include turning the climate control device control unit off or on. Controlling the climate control device can include switching between controlling the climate control device using a first climate control device control unit and a second climate control device control unit. The method can also include transmitting an acknowledgement signal to a remote communication device. The climate control device can be selected from the group consisting of a heater, a cooler, a humidifier, a dehumidifier, a filtration system, an electronic window tinting system, a blinds system, a curtain system and a shade system.

Additional features and advantages are described herein, and will be apparent from, the following Detailed Description and the figures.

### BRIEF DESCRIPTION OF THE FIGURES

FIG. 1 is a diagram of an exemplary climate control system in accordance with one embodiment of the present invention.

FIG. 2 is a flow chart of a process of controlling a climate control system having a single, non-programmable thermostat in accordance with one embodiment.

FIG. 3 is a flow chart of a process of controlling a climate control system having a single, non-programmable thermostat, wherein a password is entered before a command is executed in accordance with one embodiment.

FIG. 4 is a flow chart of a process of controlling a climate control system having a single, programmable thermostat in accordance with one embodiment.

FIG. 5 is a flow chart of a process of controlling a climate control system having two thermostats in accordance with one embodiment.

FIG. 6 is a flow chart of a process of controlling a climate control system that sends and acknowledgement signal in accordance with one embodiment.

FIG. 7 is a flow chart of a process of controlling a climate control system by calling a controller unit in accordance with one embodiment.

FIG. 8 is a flow chart of a process of controlling a climate control system by sending a message to a controller unit via a computer network such as the Internet in accordance with one embodiment.

### DETAILED DESCRIPTION

In various embodiments, a controller for a climate control system is provided. The controller can be a thermostat or any other suitable controller. The climate control system can be a heating and/or cooling system or any other suitable system, including but not limited to humidity control systems, filtration systems, electronic window tinting systems, blinds systems (e.g., a system that controls whether blinds on one or more windows are open or closed), curtain systems (e.g., a system that controls whether one or more curtains on one or more windows are open or closed) or shade systems (e.g., a system that controls whether one or more shades on one or more windows are open or closed). Preferably, the controller includes an audio input device (e.g., a microphone or other suitable sound detection device); however, an audio input device is not required by various embodiments.

The controller also preferably includes a processor, circuit or any other suitable device. Preferably, the processor is coupled to the audio input device and is capable of detecting, parsing and/or categorizing at least one sound. A sound can include one or more frequencies, one or more volume levels, one or more durations, and can include periods of silence.

Preferably, the processor controls the climate control system (e.g., turning it on or off, changing settings, or taking any other suitable action) in response to the input received from the audio device.

In an exemplary embodiment, the controller recognizes at least two phone button tones (e.g., # and *) as input. An occupant can call his or her phone number and allow an answering machine to answer. The occupant can then press one or more of the recognized buttons, which will cause the tone to be played over the answering machine speaker, if the answering machine is of the type that allows the message being left by the caller to be heard by someone present while the message is left. The tone is detected by the audio device of the controller and the controller alters the climate control system accordingly.

Thus, an occupant can remotely control the climate control system. Preferably, an occupant can control the climate control system remotely with the same ability/degree of control as if the occupant were controlling it on site; however, the occupant can have greater or lesser control remotely than when present, if desired.

Embodiments of the present invention can include standard on/off thermostats, programmable thermostats and/or any other suitable climate control system controllers. Preferably, the pre-set program of a programmable thermostat is overridden by the audio input provided to the controller. As a result, an occupant can override the programming of the programmable thermostat when the occupant will be home earlier than usual or out later than usual.

One embodiment includes primary and secondary thermostats. The controller is preferably operable to determine which of the primary and secondary thermostats are used when operating the climate control system. For example, a first thermostat is programmed to keep the climate control system off until 10 PM, at which time the thermostat causes the climate control system to maintain a temperature of at least 60 degrees. Such a setting may work well for an occupant who is typically out until 10:30 and who is comfortable at 60 degrees. A second thermostat is configured to cause the climate control system to maintain a temperature of at least 80 degrees at all times. As a result, the occupant can have the first thermostat in operation in most situations. Then, if the occupant discovers that he will be returning home early with company who prefers a temperature of at least 80 degrees, the occupant can call home and change the operative thermostat from the first thermostat to the second thermostat.

Preferably, each recognized sound is a distinct command causing a distinct response from the controller (e.g., * meaning “system on” and # meaning “system off” or vice versa); however, sounds can be combined to enable more complex remote coding and/or programming of the controller. The combination of two or more sounds is preferably made by placing the sounds in sequence, however sounds can be combined in any suitable manner.

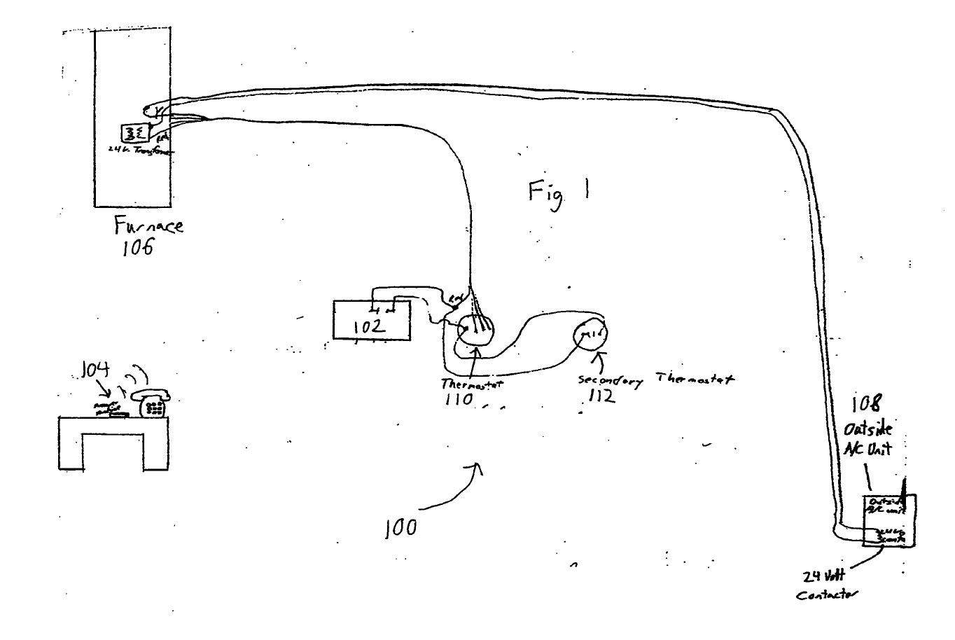

FIG. 1 illustrates an exemplary climate control system 100 in accordance with one embodiment. A controller 102 is capable of receiving audio input that is transmitted via an answering machine 104 and controlling the furnace 106 and/or air conditioning unit 108 in accordance with the received audio input. More specifically, the controller 102 is operable to switch which of a primary 110 and secondary thermostat 112 is in operation with the furnace 106 and/or air conditioning unit 108. Preferably, the controller 102 includes a switch, and when the switch is closed, power flows through the primary thermostat 110. When the switch is open, power flows through the secondary thermostat 112. However, the controller is not required to include a switch and the system 100 is not required to have more than one thermostat.

The controller 102 can include sound filters to improve performance of the system. For example, a noise filter may remove the sound of a dog barking, a refrigerator running and/or any other expected and/or unexpected background noise from the inputted sound to cause more efficient detection of audio input. Further, the controller can include voice recognition software so that the system recognizes spoken words as sound input and/or recognizes only words spoken by one or more authorized individuals as sound input.

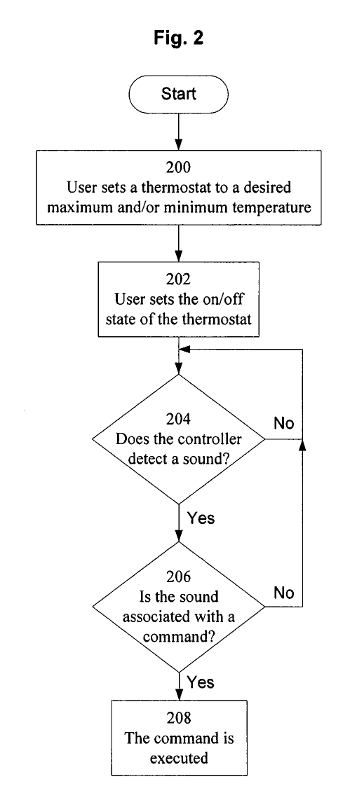

FIG. 2 shows a process of controlling a climate control system having a single, non-programmable thermostat in accordance with one embodiment. At block 200, a user sets a thermostat to a desired maximum and/or minimum temperature. At block 202, the user sets the on/off state of the thermostat. For example, the user may set the on/off state to off before leaving the house when the user anticipates being away for a lengthy period and does not want the heater or air conditioner to operate during that period. Alternatively, the user may set the on/off state to on before leaving the house when the user anticipates returning shortly.

At block 204, it is determined whether the controller detects a sound. If the controller does not detect a sound, the process repeats at block 204. If the controller detects a sound, at block 206, it is determined whether the sound is associated with a command. For example, the tone emitted by the answering machine when a caller presses “*” is associated with setting the on/off state to on, and the tone emitted by the answering machine when a caller presses “#” is associated with setting the on/off state to off. It should be appreciated that any suitable sound or sounds can be associated with any suitable command. If the sound is not associated with a command, the process repeats at block 204. If the sound is associated with a command, at block 208, the command is executed.

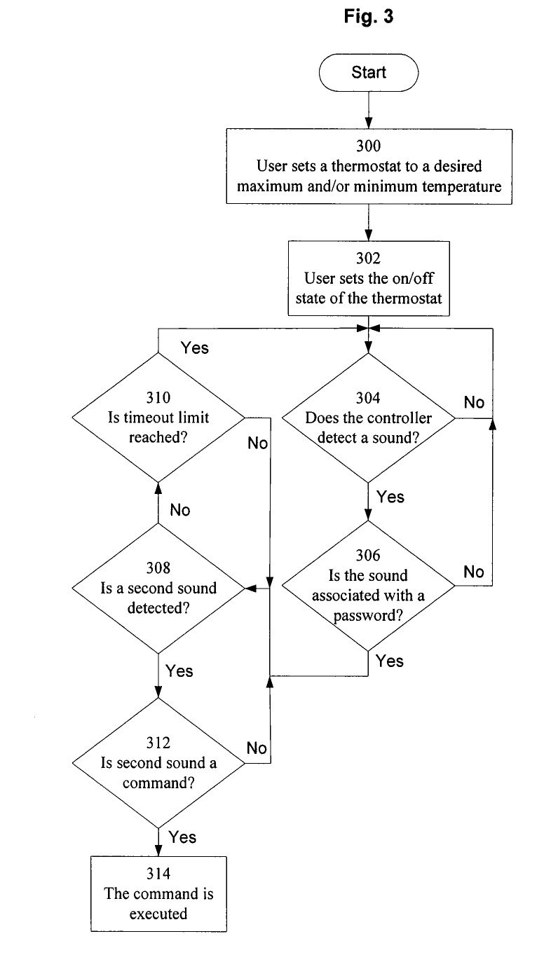

FIG. 3 shows a process of controlling a climate control system having a single, non-programmable thermostat, wherein a password is entered before a command is executed in accordance with one embodiment. By requiring a password to be entered, the system can prevent accidental or intentional (e.g., by a prankster) execution of commands. At block 300, a user sets a thermostat to a desired maximum and/or minimum temperature. At block 302, the user sets the on/off state of the thermostat. At block 304, it is determined whether the controller detects a sound. If the controller does not detect a sound, the process repeats at block 304. If the controller detects a sound, at block 306, it is determined whether the sound is associated with a password. A password can be any suitable sound, including but not limited to a single tone or a series of tones emitted by an answering machine speaker in response to key presses by a caller. For example, a password could be the digits 1, 2, 3 and 4 being entered by the caller sequentially. Preferably, the occupant can select a password and program it into the controller. If the sound is not associated with a password, the process repeats at block 304.

If the sound is associated with a password, at block 308, it is determined whether a second sound is detected. If a second sound is not detected, at block 310 it is determined whether a timeout limit is reached. If the timeout limit is reached, the process repeats at block 304. If the timeout limit is not reached, the process repeats at block 308. If a second sound is detected, at block 312, it is determined whether the second sound is a command. If the second sound is not a command, the process repeats at step 308. If the second sound is a command, at step 314, the command is executed.

In one embodiment, the controller can detect more than one password. As a result, two or more occupants can have different passwords. Further, the controller can maintain a rule system for determining whether to execute a command depending on which password was detected, the time of day, previous remotely entered commands or any other suitable conditions for rules. For example, a parent and child can have two different passwords. Further, commands issued under the parent's password override commands entered under the child's password. In one embodiment, the parent's commands cannot be overridden by the child even if the child is home. Instead, the parent can enter another command either remotely or by a local interface to release control of the climate control system. For example, a parent may be willing to allow the child to turn the air conditioning back on early on relatively cool days, but unwilling to allow the air conditioning to be turned on early on extremely hot days, when the parent would prefer the child find air conditioning somewhere else (such as a mall or a friend's house).

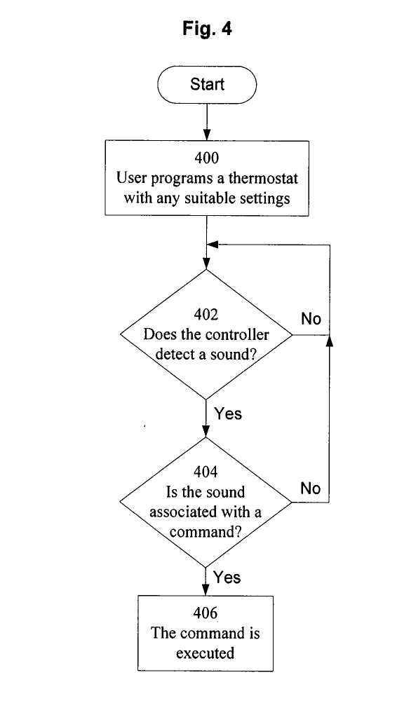

FIG. 4 shows a process of controlling a climate control system having a single, programmable thermostat in accordance with one embodiment. At block 400, a user programs a thermostat with any suitable settings. At block 402, it is determined whether the controller detects a sound. If the controller does not detect a sound, the process repeats at block 402. If the controller detects a sound, at block 404, it is determined whether the sound is associated with a command. The command can be any suitable command, including changing from a primary program setting to a secondary program setting, resetting a maximum or minimum temperature, resetting a time of activation, turning a heating or cooling unit on or off, or any other suitable action. If the sound is not associated with a command, the process repeats at block 402. If the sound is associated with a command, at block 406, the command is executed.

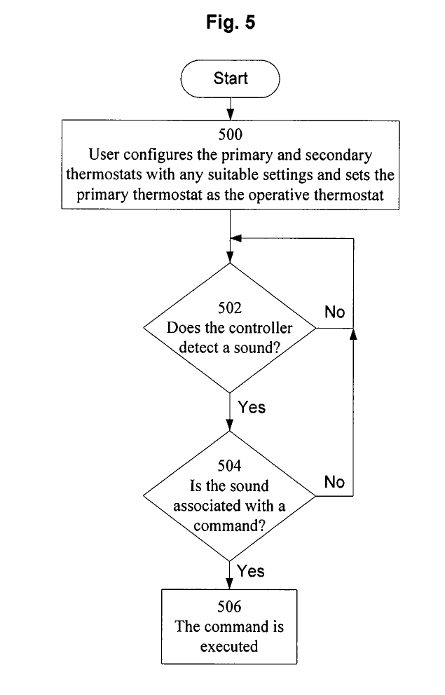

FIG. 5 shows a process of controlling a climate control system having two thermostats in accordance with one embodiment. Either one or both of the thermostats can be programmable. At block 500, a user configures the primary and secondary thermostats with any suitable settings and sets the primary thermostat as the operative thermostat. At block 502, it is determined whether the controller detects a sound. If the controller does not detect a sound, the process repeats at block 502. If the controller detects a sound, at block 504, it is determined whether the sound is associated with a command. The command can be any suitable command, including changing which thermostat is operative, changing the configuration of either of the thermostats, or any other suitable action. If the sound is not associated with a command, the process repeats at block 502. If the sound is associated with a command, at block 506, the command is executed.

In one embodiment, the controller includes a communication device capable of sending a signal to a remote communication device. The remote communication device can be a pager, cell phone, personal digital assistant, computer, telephone or any other suitable device. The signal can be sent via a telephone system, cellular system, a powerline communication system, the Internet or any other suitable communications system. The signal can be an acknowledgement of receipt of the remote audio instructions and can include the present state of the controller or the instructions that were received via remote audio input. Further, the signal can include acknowledgement of an attempted, but failed attempt to remotely instruct the control system. Further, the signal can be sent to a pre-programmed remote communication device and/or a dynamically determined remote communication device (e.g., the telephone from which the occupant called).

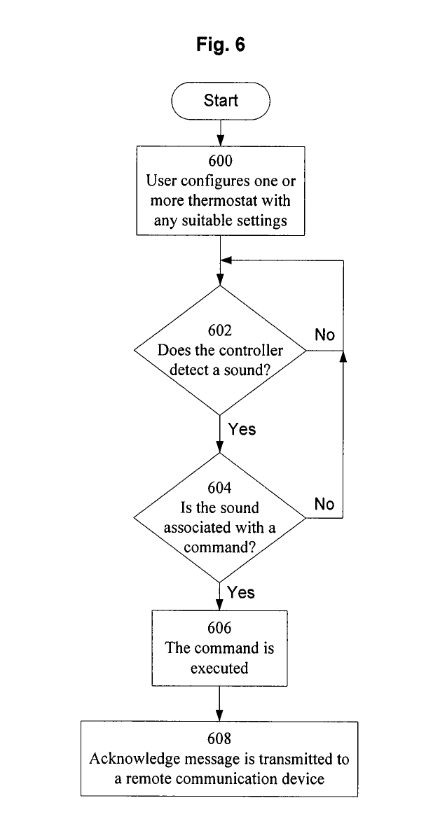

FIG. 6 shows a process of controlling a climate control system that sends and acknowledgement signal in accordance with one embodiment. At block 600, a user configures one or more thermostat with any suitable settings. At block 602, it is determined whether the controller detects a sound. If the controller does not detect a sound, the process repeats at block 602. If the controller detects a sound, at block 604, it is determined whether the sound is associated with a command. If the sound is not associated with a command, the process repeats at block 602. If the sound is associated with a command, at block 606, the command is executed. At block 608, an acknowledge message is transmitted to a remote communication device.

Alternatively, the controller could be connected to and receive remote input via any other communications system, including but not limited to the Internet (e-mail, instant message, FTP or any other suitable communication), a telephone network (a call directly to the controller rather than through the answering machine), a satellite network or any other communications system.

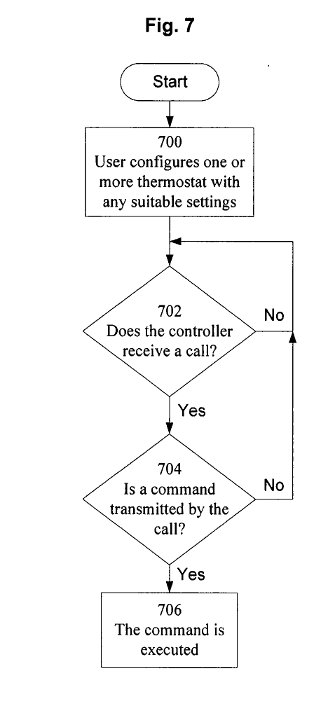

FIG. 7 shows a process of controlling a climate control system by calling a controller unit in accordance with one embodiment. At block 700, a user programs one or more thermostats with any suitable settings. At block 702, it is determined whether the controller receives a call. Preferably, the controller is operable, similar to an answering or fax machine, to detect and answer an incoming call. Further, the controller is preferably operable to share one or more phone lines with one or more telephones, answering machines, fax devices, modems or any other suitable devices. If the controller does not receive a call, the process repeats at block 702. If the controller receives a call, at block 704, it is determined whether a command is transmitted by the call. If a command is not transmitted by the call, the process repeats at block 702. If a command is transmitted by the call, at block 706, the command is executed.

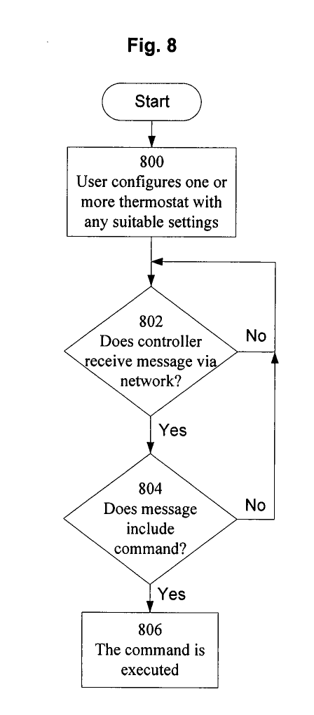

FIG. 8 shows a process of controlling a climate control system by sending a message to a controller unit via a computer network such as the Internet in accordance with one embodiment. At block 800, a user configures one or more thermostats with any suitable settings. At block 802, it is determined whether the controller receives a message via a computer network. If the controller does not receive a message, the process repeats at block 802. If the controller receives a message, at block 804, it is determined whether the message includes a command. If the message does not include a command, the process repeats at block 802. If the message includes a command, at block 806, the command is executed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A climate control system comprising:
a remote signal input device; and
a controller operable to receive input from the remote signal input device and control a climate control device at least partly in response to the input, the climate control device being operable to change or maintain an environmental condition of an enclosure.

2. The climate control system of claim 1, wherein the remote signal input device is an audio input device.

3. The climate control system of claim 2, wherein the remote signal input device is configured to receive an audio input emitted from a speaker of an answering machine.

4. The climate control system of claim 3, wherein the controller is configured to control the climate control device if the input includes a password.

5. The climate control system of claim 1, wherein the controller is configured to control the climate control device by changing one or more settings of a climate control device control unit.

6. The climate control system of claim 5, wherein the climate control device control unit is a thermostat.

7. The climate control system of claim 5, wherein changing one or more settings of the climate control device control unit includes turning the climate control device control unit off or on.

8. The climate control system of claim 1, wherein the controller is configured to control the climate control device by switching between controlling the climate control device using a first climate control device control unit and a second climate control device control unit.

9. The climate control system of claim 1, further comprising:
a transmission unit configured to send an acknowledgement signal to a remote communication device.

10. The climate control system of claim 1, wherein the climate control device is selected from the group consisting of a heater, a cooler, a humidifier, a dehumidifier, a filtration system, an electronic window tinting system, a blinds system, a curtain system and a shade system.

11. A method of controlling an environmental condition of an enclosure comprising:
receiving input at a remote signal input device; and
controlling a climate control device at least partly in response to the input, the climate control device being operable to change or maintain the environmental condition.

12. The method of claim 11, wherein the remote signal input device is an audio input device.

13. The method of claim 12, wherein receiving input includes receiving an audio input emitted from a speaker of an answering machine.

14. The method of claim 13, controlling the climate control device includes determining whether the input includes a password.

15. The method of claim 14, wherein controlling the climate control device includes changing one or more settings of a climate control device control unit.

16. The method of claim 15, wherein the climate control device control unit is a thermostat.

17. The method of claim 15, wherein changing one or more settings of the climate control device control unit includes turning the climate control device control unit off or on.

18. The method of claim 11, wherein controlling the climate control device includes switching between controlling the climate control device using a first climate control device control unit and a second climate control device control unit.

19. The method of claim 11, further comprising:
transmitting an acknowledgement signal to a remote communication device.

20. The method of claim 11, wherein the climate control device is selected from the group consisting of a heater, a cooler, a humidifier, a dehumidifier, a filtration system, an electronic window tinting system, a blinds system, a curtain system and a shade system.
